(19) United States
(12) Patent Application Publication
(10) Pub. No.: US 2003/0038853 A1
(43) Pub. Date: Feb. 27, 2003

(54) Image forming apparatus and method of forming image

(75) Inventor: Jun Moroo, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: FUJITSU LIMITED, Kawasaki (JP)

(21) Appl. No.: 10/272,830

(22) Filed: Oct. 18, 2002

Related U.S. Application Data
(63) Continuation of application No. PCT/JP00/03950, filed on Jun. 16, 2000.

(51) Int. Cl. B41J 2/205

(52) U.S. Cl. 347/15

(57) ABSTRACT

An object of the present invention is that, in an image forming apparatus, even if deviation in the dot array forming position is brought about, the change in the dot forming condition due to the positional deviation is made inconspicuous. To this end, the image forming apparatus of the present invention is arranged to include a dot size determining unit for determining a size of dot to be formed on each pixel region based on inputted image data, an image forming unit for forming a dot having a size determined by the dot size determining unit so as to create a multilevel gray scale image, and preventing means for preventing the dot size from being determined by the dot size determining unit in such a manner that dots having an identical size falling within a predetermined range are continuously arrayed in pixel regions neighboring one another.

### TECHNICAL FIELD

The present invention relates to an image forming apparatus such as an ink jet printer and a thermal printer which employ various kinds of methods such as density pattern method, an ordered dither method, an error diffusion method, a blue-noise mask method, a digital screening method and so on to form a multilevel gray scale image. The present inventional sore lates to a method of forming an image using such an apparatus.

### BACKGROUND ART

In general, an ink jet printer has a function of adjusting the size of dot [i.e., arate of an area occupied by a dot assigned to a single unit of pixel (one pixel)], so that a multilevel gray scale image can be created by such a printer.

Now, description will be made on an operation of an ink jet printer in which a size (diameter) of dot to be formed in each pixel region (pixel) can be selected from five levels of dot sizes, or levels of 1, 2, 3, 4 and 5.

Meanwhile, the numerals 1, 2, 3, 4 and 5 representing the dot size are not those indicating the actual size of dot (diameter) but those indicating a level of dot size (tone level). If the numeral is large, which means that the corresponding dot size is large. Therefore, “level 1” means the smallest dot diameter and “level 5” means the largest dot diameter. The dot diameter of level 5, i.e., the largest size (diameter) is ordinarily set to 2½ times the dot pitch (the center distance between dots adjacent to each other) or more. However, “level 0” means a empty pixel region, i.e., there is no dot formed in the corresponding pixel region.

Inputted image data supplied to the ink jet printer has 256 levels of tone (i.e., tone number 0 to tone number 255), for example, at every pixel. When the ink jet printer receives the data, the printer converts a value given to each pixel into any of aforesaid levels 0 to 5. Then, the ink jet printer forms a dot with a size corresponding to the converted result in each pixel region. Thus, a multilevel gray scale image can be created.

Now, description will be made with reference to FIGS. 12 and 13 on a case in which an ordered dither method is introduced as a method for converting a value of each pixel in the inputted image data into the aforesaid six levels.

When the ordered dither method is employed, for example, a threshold value mask of 4×4 matrix (4×4 dither matrix) is utilized to convert the aforesaid inputted image data (respective pixel values) into any of 81 kinds of 4×4 dot patterns shown in FIG. 12, for example, for every 4×4 pixel block. That is, the ink jet printer described in this case handles the inputted image data based on the 256-division of tone levels as 4×4 dot pattern based on 81-division of tone levels.

In FIG. 12, dot patterns after undergoing the aforesaid conversion are expressed by numerals of 0 to 5 representing the above-described levels. As shown in FIG. 12, there are shown 1^{st} to 19^{th} dot patterns (dot patterns of tone numbers 0 to 18) and 64^{th} to 81^{st} dot patterns (dot patterns of tone numbers 63 to 80). Therefore, 20^{th} to 63^{rd} dot patterns(dot patterns of tone numbers 19 to 62) are not shown.

Now, description will be made with reference to FIG. 12 on how the numeral representing the dot size level is incremented at the leftmost pixel region of the uppermost row (first row of first column) of the 4×4 pixel block. For example, if the inputted image data value ranges from 0 to 2, the dot size level takes a value of level 0. If the inputted image data value ranges from 3 to 50, the dot size level takes a value of level 1. If the inputted image data value ranges from 51 to 100, the dot size level takes a value of level 2. If the inputted image data value ranges from 101 to 152, the dot size level takes a value of level 3. If the inputted image data value ranges from 152 to 204, the dot size level takes a value of level 4. And if the inputted image data value ranges from 205 to 255, the dot size level takes a value of level 5. In this way, the aforesaid threshold value mask is determined in advance.

Further, the dot size level of the pixel region at the second row of the third column of the 4×4 pixel block is incremented as follows. That is, for example, if the inputted image data value ranges from 0 to 47, the dot size level takes a value of level 0. If the inputted image data value ranges from 48 to 96, the dot size level takes a value of level 1. If the inputted image data value ranges from 97 to 148, the dot size level takes a value of level 2. If the inputted image data value ranges from 149 to 200, the dot size level takes a value of level 3. If the inputted image data value ranges from 201 to 251, the dot size level takes a value of level 4. And if the inputted image data value ranges from 252 to 255, the dot size level takes a value of level 5. In this way, the aforesaid threshold value mask is determined in advance.

As described above, a set of threshold values for converting the pixel data into the dot size level are predetermined in advance for each cell of the 4×4 pixel block. Thus, a set of the threshold value masks is prepared in advance.

FIG. 13 is a graph illustrating a relationship between a rate of number of pixel regions filled with dots of the respective levels (1 to 5) to the total pixel regions constituting the 4×4 dot pattern shown in FIG. 12, and 256-division tone levels and 81-division tone level of 4×4 dot pattern. As shown in FIG. 13, the 81-division tone levels (0 to 80) of the dot patterns shown in FIG. 12 are associated with the 256-division tone levels (0 to 255) of the inputted image data.

The pixel regions of the 4×4 dot pattern are filled with dots one by one as the tone number is increased in a manner as follows. That is, initially, the pixel regions of the 4×4 dot pattern are filled with-dots of level 1 one by one as the tone level number is increased until all the pixel regions of the 4×4 dot pattern are filled with dots of level 1. When all of the pixel regions of the 4×4 dot pattern are filled with dots of level 1, then the dot of level 1 is replaced with a dot of level 2 one by one. When all of the pixel regions of the 4×4 dot pattern are filled with dots of level 2, then the dot of level 2 is replaced with a dot of level 3 one by one. In a similar manner, the dot currently filling the pixel region is replaced with a dot of larger size as the tone number is increased. If all of the pixel regions of the 4×4 matrix are filled with dots of level 5 (100%), this state corresponds to the state of tone number of 255 (the matrix is completely filled with the dots).

Meanwhile, if the ink jet printer is one forming a binary digit image, the image is formed of only one kind of dots. In general, the size of the dot (dot diameter) is set to 2½ times the dot pitch (the center distance between dots adjacent to each other) or more. That is, the image is formed by using only the dot of the aforesaid level 5.

If an image forming region is completely filled with the dots of this size, as for example shown in FIG. 14, the image forming region will be applied with solid painting so that no empty space is left in the region. FIG. 14 shows the solid painted state of the image forming region in which six dot columns each formed of six dots are provided so as to extend in the lateral direction (left-right direction in the figure). In the example shown in FIG. 14, all dot pitches are identical to one another.

When an image is formed by the aforesaid binary digit ink jet printer, even if slight deviation is caused between the dot rows adjacent to each other in the ink drop traveling direction, no problem will be caused on the image forming region applied with the solid painting so long as the respective dots have the above-described size. Therefore, the image can be free from serious influence from the deviation.

For example, FIG. 15 shows a state of an image forming region applied with a solid painting which is created by providing six dot columns each formed of six dots on the image forming region similarly to the case of FIG. 14. In the example shown in FIG. 15, a slight deviation is brought about in the ink drop traveling direction due to any cause, with the result that distance (dot pitch) p0 between the third dot row and fourth dot row is slightly expanded as compared with other ordinary dot pitch. However, as will be clearly understood from FIG. 15, no problem is brought about in the solid painting state of the image forming region, and hence the solid painting state is maintained with dots in the image forming region.

On the other hand, as has been described with reference to FIGS. 12 and 13, if an ink jet printer prepares a plural number of dot sizes and properly selects one of them upon forming a multilevel gray scale image (image formed of multi-values), some of the dot sizes can be naturally smaller than 2½ times the dot pitch.

FIGS. 16 and 17 are diagrams each showing an example of an image forming region completely filled with dots having substantially the same diameter as the dot pitch (e.g., dot of the aforesaid level 4). As shown in FIGS. 16 and 17, similarly to the case of FIGS. 14 and 15, six dot rows are formed on the image forming region.

In the example shown in FIG. 16, the above-described deviation is not caused, and the six dot row (36 dots) are formed with all dot pitch maintained equally. That is, the dots are uniformly distributed over the image forming region and the image forming region thereof is somewhat brighter than the examples of FIG. 14 and 15.

Conversely, in the example shown in FIG. 17, similarly to the example shown in FIG. 15, a slight deviation is brought about in the ink drop traveling direction due to any cause, making the fourth row and subsequent rows be formed at positions which are deviated from respective ideal positions on which the rows are to be formed. As a result, distance (dot pitch) p0 between the third dot row and fourth dot row is slightly expanded as compared with other distances which are set to the ordinary dot pitch. At this time, as shown in FIG. 17, if each of the dots has a size substantially equal to the dot pitch, only slight positional deviation will cause the gap between the dots and this gap becomes conspicuous as a band. As a consequence, this band deteriorates seriously the image formed on the image forming region in its image quality.

The above-described phenomenon becomes conspicuous when the dot size and the dot pitch are substantially equal to each other. If the dot size is set to 2½ times the dot pitch or around it, then any position deviation will cause no gap between the dot rows and the band will not become conspicuous. Also, if the dot size is set to be small and the gap between the dot rows becomes sufficiently large, the formed image will not be influenced from the positional deviation, and the band will not become conspicuous.

The above-described phenomenon can be brought about not only in the image forming situation by an ink jet printer but also in the image forming situation by a thermal printer. In the thermal printer, if a head thereof is slightly tilted in its angle, the a band similar to that described above can be caused, with the result that the image quality will be deteriorated.

In other words, as the degree of multilevel gray scale representation (multi-value representation) is progressed in an image forming apparatus such as an ink jet printer or a thermal printer, it is requested to establish a high degree of addressability in the ink drop traveling direction control or a head mechanism positioning control. As a consequence, a problem of image quality deterioration is brought about.

The present invention seeks to solve the above-identified problem. Therefore, it is an object of the present invention to provide an image forming apparatus and a method of forming an image in which even if dot rows are formed at positions which are deviated from respective ideal positions due to a problem of addressability, an irregularity in the dot forming state due to the positional deviation is made inconspicuous, whereby the image can be prevented from being deteriorated in the quality thereof.

### DISCLOSURE OF THE INVENTION

According to the present invention, in order to attain the above object, there is provided an image forming apparatus characterized by including a dot size determining unit for determining a size of dot to be formed on each pixel region based on inputted image data, an image forming unit for forming a dot, having a size determined by the dot size determining unit, in the pixel region corresponding to the dot so as to create a multilevel gray scale image, and preventing means for preventing the dot size from being determined by the dot size determining unit in such a manner that dots having an identical size falling within a predetermined range are continuously arrayed in pixel regions neighboring one another.

Further, according to the present invention, there is proposed a method of forming an image including the steps of determining a size of dot to be formed in each pixel region based on inputted image data, and forming a multilevel gray scale image in such a manner that a dot having a size determined by the step of determining the dot size is formed in the pixel region corresponding to the dot, wherein in the step of determining the dot size, control is effected to avoid a case in which dots having an identical size falling within a predetermined range are continuously arrayed in pixel regions which are arrayed straight.

According to the image forming apparatus and the method of forming an image of the present invention, dots having the same size can be prevented from being arrayed or formed on pixel regions which are sequentially arrayed to form a row of pixel regions. Therefore, even if dot rows are formed at positions which are deviated from respective ideal positions due to a problem of addressability, an irregularity in the dot forming state due to the positional deviation is made inconspicuous. Thus, the image can be protected from image quality deterioration. Accordingly, it becomes unnecessary to secure a stringent accuracy in the positional deviation due to a problem of addressability, with the result that an image having a high quality can be created.

In the above-described image forming apparatus of the present invention, the dot size determining unit may refer to a predetermined set of dither matrices each time the dot size determining unit is supplied with a piece of image data corresponding to a matrix-like pixel block, and select a matrix-like dot corresponding to the pixel block by determining the size of each dot to be formed in a corresponding pixel region constituting the pixel block so that a tone number of the image data corresponding to the matrix-like pixel block is associated with corresponding one of the dither matrices, and the preventing means may be arranged to prevent the dot size determining unit from selecting a dot pattern in which the dots having an identical size falling within a predetermined range are continuously arrayed in the pixel regions which constitute the pixel block and are neighboring one another.

At this time, the preventing means may be arranged to prevent the dot size determining unit from selecting a dot pattern in which the number of pixel regions filled with a dot having a size falling within a predetermined range exceeds a predetermined rate to the total number of pixel regions constituting the pixel block.

Further, the dot size determining unit may select a dot pattern from among a set of possible dot patterns which are prepared in such a manner that a dot of first size falling within the predetermined range is increased one by one in accordance with the tone number and arrayed in any of the pixel regions constituting the pixel block, and when the number of pixel regions filled with the dot of first size exceeds the predetermined rate to the total number of pixel regions, the dot of first size is replaced one by one with a dot of second size which is larger than the dot of first size in accordance with the tone number.

Further, the dot size determining unit may select a dot pattern from among a set of possible dot patterns which are prepared in such a manner that if the second size is one larger than the predetermined range, all dots of first size are replaced with the dots of second size and thereafter the dot of second size is assigned one by one to a vacant pixel region of the pixel block in accordance with the tone number until all of the pixel regions constituting the pixel block are filled with the dot of second size.

Further, the preventing means may have a function for changing the setting of the predetermined rate depending on the size. Furthermore, the preventing means may have a function for changing the setting of the predetermined rate depending on the surrounding image condition of the pixel block.

On the other hand, the image forming apparatus according to the present invention may be arranged so that the dot size determining unit employs an error diffusion method, and determines a size of dot to be formed on the target pixel region in such a manner that a tone level corresponding to the tone number is determined by comparing a tone number, having undergone the error diffusion processing based on the image data, with a plurality of threshold value and thereafter the size of dot to be formed on the target pixel region is determined depending on the tone level, and the preventing means may be arranged to avoid a dot size arrangement in which the size of dot formed in the target pixel region is identical to the size of dot having been formed in the pixel region adjacent to the target pixel region in the sub-scanning direction.

At this time, the dot size determining unit may include a threshold table for holding therein the plurality of threshold values utilized when the dot size determining unit carries out the comparing processing to determine the tone level, and the preventing means may extract from the threshold table a threshold value which has been utilized as a reference for determining the tone level of the pixel region adjacent to the target pixel region before the dot size determining unit determines the tone level of the target pixel region.

### BRIEF DESCRIPTION OF THE DRAWINGS

FIG. 1 is a block diagram showing a fundamental arrangement of an image forming apparatus according to the present invention;

FIG. 2 is a diagram showing a first example of dot group (containing no positional deviation) formed by the image forming apparatus according to the present invention;

FIG. 3 is a diagram showing a second example of dot group (containing no positional deviation) formed by the image forming apparatus according to the present invention;

FIG. 4 is a diagram showing a dot group which is similar to that shown in FIG. 2 but contains a positional deviation brought about upon forming the dot group;

FIG. 5 is a diagram showing a dot group which is similar to that shown in FIG. 3 but contains a positional deviation brought about upon forming the dot group;

FIG. 6 is a diagram showing a modified example of a dot group formed by the image forming apparatus according to the present invention;

FIG. 7 is a block diagram showing an arrangement of an image forming apparatus as a first embodiment of the present invention;

FIG. 8 is a diagram for explaining concrete examples of dot patterns utilized in the first embodiment of the present invention;

FIG. 9 is a graph showing a relationship between a rate of pixel regions filled with a dot having any of predetermined sizes to all number of pixel regions constituting the dot pattern shown in FIG. 8, and 256-division of tone levels and 41-division of tone levels defined by the dot patterns shown in FIG. 8;

FIG. 10 is a block diagram showing an arrangement of an image forming apparatus as a second embodiment of the present invention;

FIG. 11 is a flowchart for explaining an operation of the second embodiment of the present invention;

FIG. 12 is a diagram for explaining concrete examples of dot patterns utilized when an ordered dither method is employed;

FIG. 13 is a graph showing a relationship between a rate of pixel regions filled with a dot having any of predetermined sizes to all number of pixel regions constituting the dot pattern shown in FIG. 12, and 256-division of tone levels and 81-division of tone levels defined by the dot patterns shown in FIG. 12;

FIG. 14 is a diagram showing a first example of dot group (containing no positional deviation) formed by a conventional image forming apparatus;

FIG. 15 is a diagram showing a dot group which is similar to that shown in FIG. 14 but contains a positional deviation brought about upon forming the dot group;

FIG. 16 is a diagram showing a second example of dot group (containing no positional deviation) formed by a conventional image forming apparatus; and

FIG. 17 is a diagram showing a dot group which is similar to that shown in FIG. 16 but contains a positional deviation brought about upon forming the dot group.

### BEST MODE FOR CARRYING OUT THE INVENTION

[0]Description of Fundamental Arrangement of Image Forming Apparatus of Present Invention

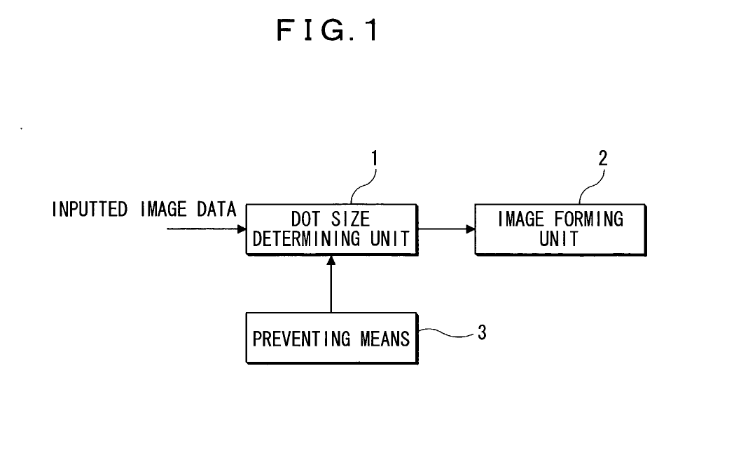

FIG. 1 is a block diagram showing a fundamental arrangement of an image forming apparatus according to the present invention. As shown in FIG. 1, the image forming apparatus of the present invention is arranged to include a dot size determining unit 1, an image forming unit 2, and preventing means 3 as fundamental components. Description will be hereinafter made on a case in which the present invention is applied to an ink jet printer.

The dot size determining unit 1 is a unit for determining the size of dot to be formed on each pixel region based on inputted image data. The image forming unit 2 is a unit for forming a dot having a size which is determined by the dot size determining unit 1 on a pixel region corresponding to the dot. Thus, a multi-level gray scale is created.

The preventing means 3 is means for preventing the dot size from being determined by the dot size determining unit 1 in such a manner that dots having an identical size falling within a predetermined range are continuously arrayed in pixel regions neighboring one another. Further, the preventing means 3 has a function for preventing the dot size determining unit from selecting a dot pattern in which the number of pixel regions filled with a dot having a size falling within a predetermined range exceeds a predetermined rate (e.g., 50%) to the total number of pixel regions constituting a pixel block.

According to the image forming apparatus of the present invention arranged as described above, initially, a dot size determining step of determining a size of dot to be formed in each pixel region is executed by the dot size determining unit 1 based on inputted image data. Subsequently, an image forming step of forming a multilevel gray scale image is executed by the image forming unit 2 in such a manner that a dot having a size determined by the step of determining the dot size is formed in the pixel region corresponding to the dot.

In the step of determining the size of dot, control is effected by the preventing means 3 to avoid a case in which dots having an identical size falling within a predetermined range are continuously arrayed in pixel regions neighboring one another. At this time, the preventing means 3 will control to avoid a dot pattern in which the number of pixel regions filled with a dot having a size falling within a predetermined range exceeds a predetermined rate (e.g., 50%) to the total number of pixel regions constituting a pixel block. Further, the preventing means 3 may have a function for changing the setting of the predetermined rate depending on the dot size (level).

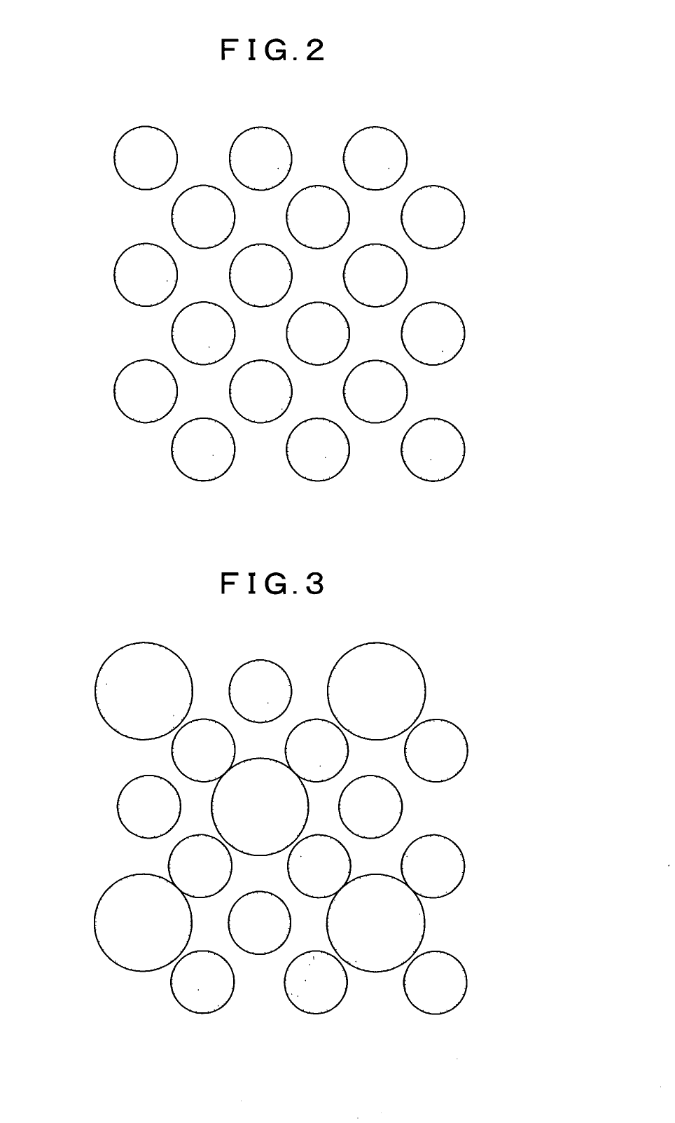

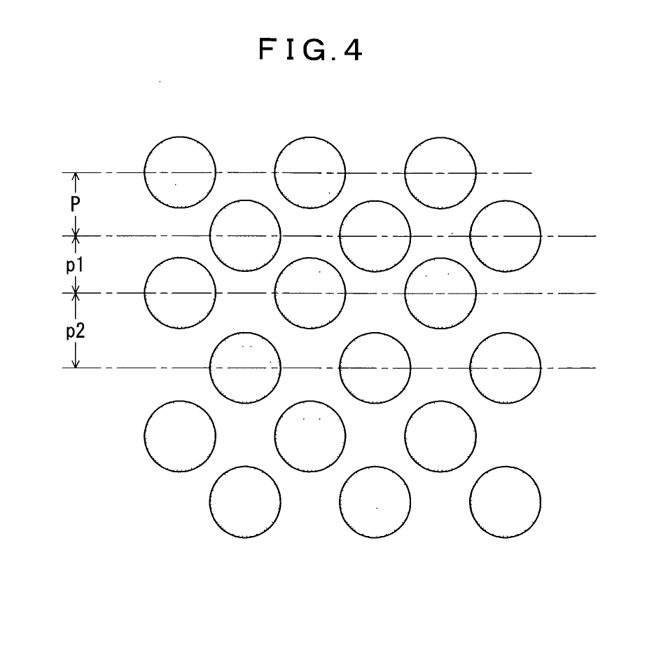

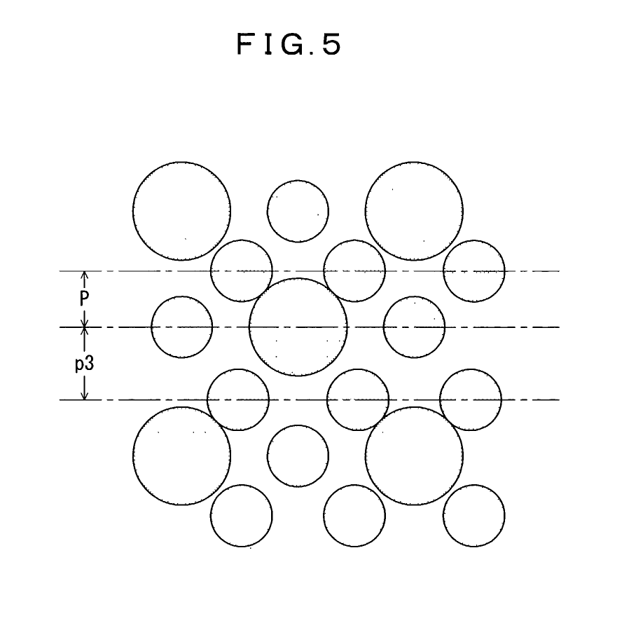

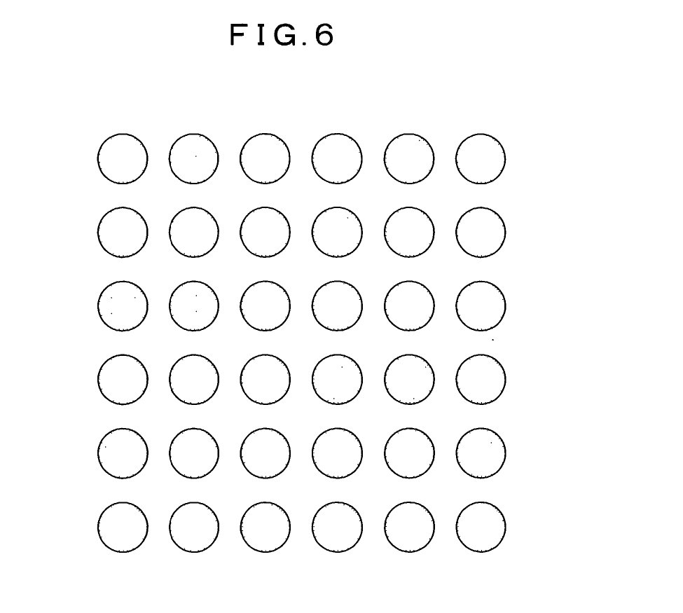

Concrete examples of dot groups formed by the above-described image forming apparatus will be described with reference to FIGS. 2 to 6. FIGS. 2 and 3 are diagrams showing a first example and a second example of dot group (containing no positional deviation) formed by the image forming apparatus according to the present invention, respectively. FIGS. 4 and 5 are diagrams showing dot groups which are similar to those shown in FIGS. 2 and 3 but contain a positional deviation brought about upon forming the dot groups, respectively. FIG. 6 is a diagram showing a modified example of a dot group formed by the image forming apparatus according to the present invention. Throughout FIGS. 2 to 6, there are shown concrete examples in which dot groups are formed on a pixel block composed of 6×6 pixel regions (pixels). That is, there is shown an example of dot matrix in which each row of dots is formed of six dots at maximum arrayed in the left-and-right direction in the figure, and the six rows of dots are arrayed in the up-and-down direction in the figure.

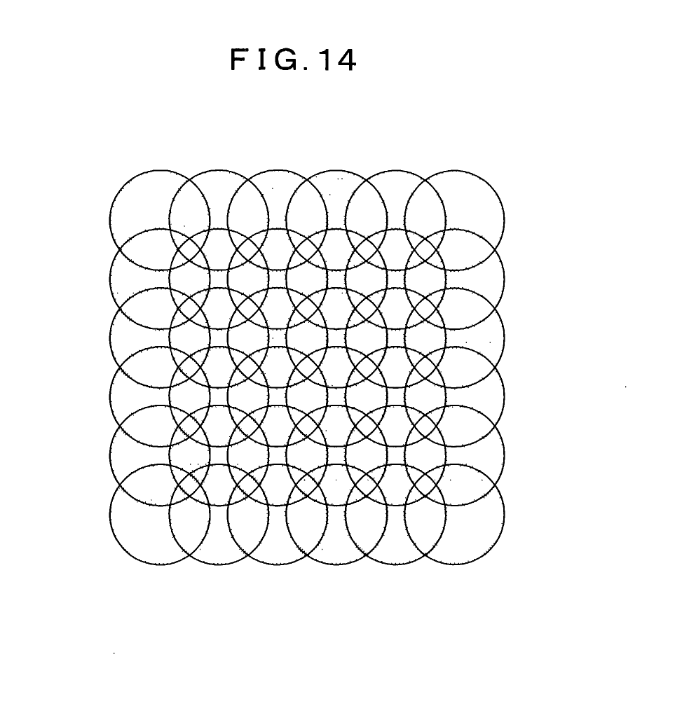

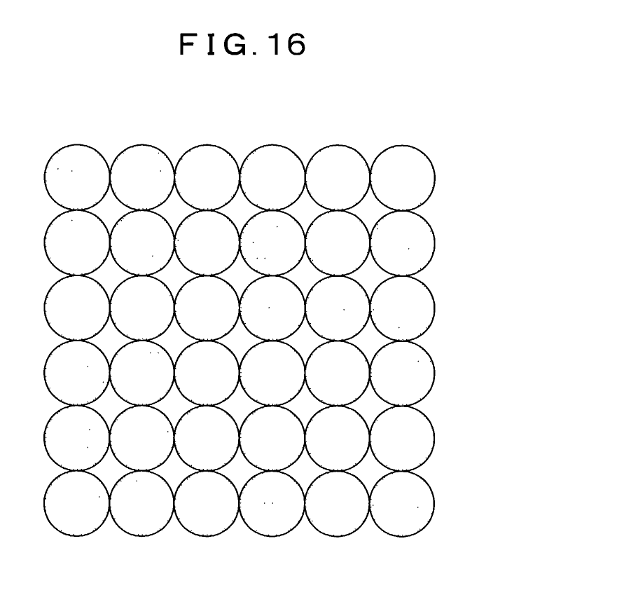

Now, in the description of the present embodiment, similarly to the aforesaid example described with reference to FIGS. 14 to 17, description will be made on a case in which the present invention is applied to an ink jet printer in which a size (diameter) of dot to be formed in each pixel region (pixel) can be selected from five levels of dot sizes, or levels of 1, 2, 3, 4 and 5.

In the present invention, as has been described above, the numerals 1, 2, 3, 4 and 5 representing the dot size are not those indicating the actual size of dot but those indicating a level of dot size (tone level). If the numeral is large, which means that the corresponding dot size is large. Therefore, “level 1” means the smallest dot diameter and “level 5” means the largest dot diameter. The dot diameter of level 5, i.e., the largest diameter is ordinarily set to 2½ times the dot pitch or more. However, “level 0” means a blank pixel region, i.e., there is no dot formed in the corresponding pixel region.

In the present embodiment, each pixel data of inputted image data has a 256 levels of tone (i.e., tone number 0 to tone number 255), for example. When the data is supplied to the dot size determining unit 1, the dot size determining unit converts a value given to each pixel into any of aforesaid levels 0 to 5. Then, the image forming unit 2 forms a dot with a size corresponding to the converted result in each pixel region. Thus, a multilevel gray scale image can be created.

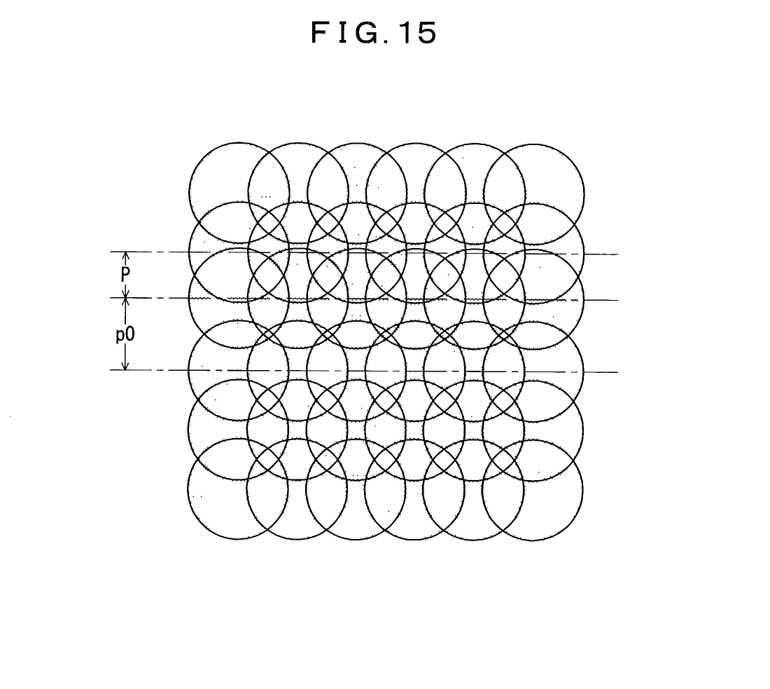

At this time, according to the image forming apparatus of the present embodiment, the preventing means 3 prevents the dot size from being determined by the dot size determining unit in such a manner that dots having an identical size falling within a predetermined range, e.g., dots each having an identical size of any of levels of 1 to 4, are continuously arrayed in pixel regions neighboring one another. As a consequence, dot groups as shown in FIGS. 2 to 5 can be created. If the dot has the maximum diameter, i.e., the size of level 5, similarly to the cases of FIGS. 14 and 15, the preventing means does not exclude a case in which the dots having the above-size are continuously assigned to the pixel regions neighboring one another.

In the example of dot rows shown in FIG. 2, dot of level 0 and dot of level 4 are provided alternately, for example. In other words, an empty pixel region (pixel) and a pixel region (pixel) filled with a dot of level 4 are alternately formed and the pixel region filled with the dot of level 4 are placed alternately in the rows adjacent to each other. Consequently, the dots of level 4 are provided to form a tessellation array as a whole. Therefore, a pixel region adjacent to a pixel region filled with the dot of level 4 is a pixel region having a dot of level 0 formed, i.e., an empty pixel region.

In the example shown in FIG. 3, the uppermost dot row has continuous six pixel regions filled with dots of level 5, level 0, level 4, level 0, level 5, and level 0, respectively. The second dot row from the top has continuous six pixel regions filled with dots of level 0, level 4, level 0, level 4, level 0, and level 4, respectively. The third dot row from the top has continuous six pixel regions filled with dots of level 4, level 0, level 5, level 0, level 4, and level 0, respectively. The fourth and sixth dot rows from the top have continuous six pixel regions filled with dots in the same manner as that of the second row. Further, the fifth dot row from the top has continuous six pixel regions filled with dots in the same manner as that of the first row. In other words, if five dots of the four level dots in the dot group shown in FIG. 2 are replaced with dots of level 5, the dot group shown in FIG. 3 is created.

In the examples shown in FIGS. 2 and 3, the preventing means 3 controls to avoid a dot pattern in which more than 50% pixel regions of the total pixel regions constituting a pixel block are filled with any of dots of level 1 to level 4. In this case, a pixel region adjacent to a pixel region filled with a dot of level 4 is one filled with a dot of level 0, i.e., an empty pixel region.

As described above, if the dot size is about 2½ times the dot pitch and hence all of the pixel regions are applied with solid painting, or alternatively, if the dot size is so small that a sufficient space can be secured between the dot rows adjacent to each other, a positional deviation of some degree will not cause conspicuous influence deriving therefrom.

Therefore, in the image forming apparatus of the present invention, the aforesaid changing function may be utilized to change the preset rate of number of pixel regions to be filled with a dot of substantial painting area depending on the dot size selection. At this time, for example, if the dot pattern is arranged to be formed of level-5 dots (the maximum diameter), as shown in FIG. 14 (FIG. 15), the preset rate of pixel regions may be set to 100%. Also, if the dot pattern is arranged to be formed of level-1 dots and level-2 dots, as shown in FIG. 6, the preset rate of pixel regions may be set to 100%.

As described above, if an image is created with the above-described dot groups by using the apparatus or the method of the present invention, the conspicuous influence deriving from the positional deviation can be suppressed in a case in which the dot size and the dot pitch are substantially equal to each other (in the above example, a case of using the level-4 dots). That is, dots having an identical size falling within a predetermined range can be effectively prevented from being arrayed continuously in pixel regions neighboring one another. Further, a pixel region adjacent to a pixel region filled with a dot is made to be an empty pixel region, with the result that it becomes possible to prevent dots of the same size from being formed and arrayed continuously.

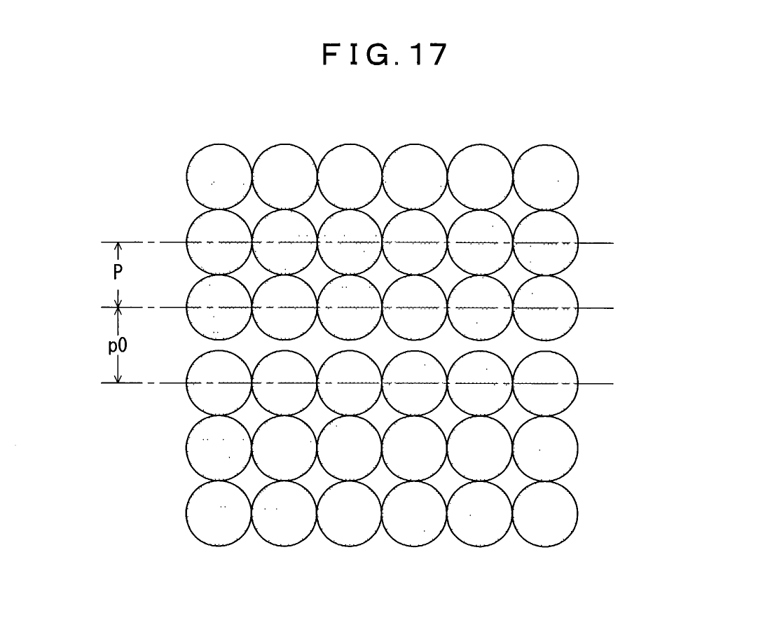

Accordingly, even if a slight deviation or the like is caused in the ink drop traveling direction, resulting in a band between the dot rows adjacent to each other, as shown in FIGS. 4 and 5, a conspicuous gap (see FIG. 17) can be prevented from appearing at the deviation portion, and the deviation will not cause serious influence on the image quality thereof.

Accordingly, even if deviation in the dot array forming position is brought about from an ideal position, causing a fluctuation in an interval of the dot array, the irregularity in the dot forming condition due to the positional deviation is made inconspicuous, so that the image quality can be reliably prevented from being deteriorated. As a result, it becomes unnecessary to secure a stringent precision for the positional deviation caused from a problem of addressability. Thus, a high quality image can be created.

FIG. 4 shows a state in which a slight deviation is brought about in the ink drop traveling direction due to any cause, with the result that the third dot row from the top corresponding to the same dot row in FIG. 2 is slightly shifted in the upper direction, the gap p1 between the second dot row from the top and the third dot row from the top becomes smaller than an ordinary dot pitch P, and the gap p2 between the third dot row from the top and the fourth dot row from the top becomes larger than the ordinary dot pitch P.

Also, FIG. 5 shows a state in which a slight deviation is brought about in the ink drop traveling direction due to any cause, with the result that a gap p3 between the third dot row from the top and the fourth dot row from the top corresponding to those of the same dot pattern in FIG. 3 is slightly expanded. While FIG. 5 is intended for explaining a case in which the dot row pitch is expanded, even if the positional deviation is brought about so that the dot row pitch is decreased, the image quality thereof can be free from deterioration due to the positional deviation, owing to the same reason as that of the above example.

Further, while FIGS. 4 and 5 are intended for explaining the case in which the positional deviation is brought about so that the gap between the dot rows extending in the lateral direction suffers from irregularity, the present invention can be effectively applied to a case in which the positional deviation is brought about so that the gap between the dot rows extending in the longitudinal direction suffers from irregularity. Also in this case, the change in the dot forming condition due to the positional deviation can be made inconspicuous, and it becomes possible to reliably suppress the deterioration in the image quality. If the positional deviation is brought about as described above, a conventional method was not able to suppress the manifestation of a band extending in the longitudinal direction. However, the present invention can effectively suppress the manifestation of such a band.

[1] Description of First Embodiment

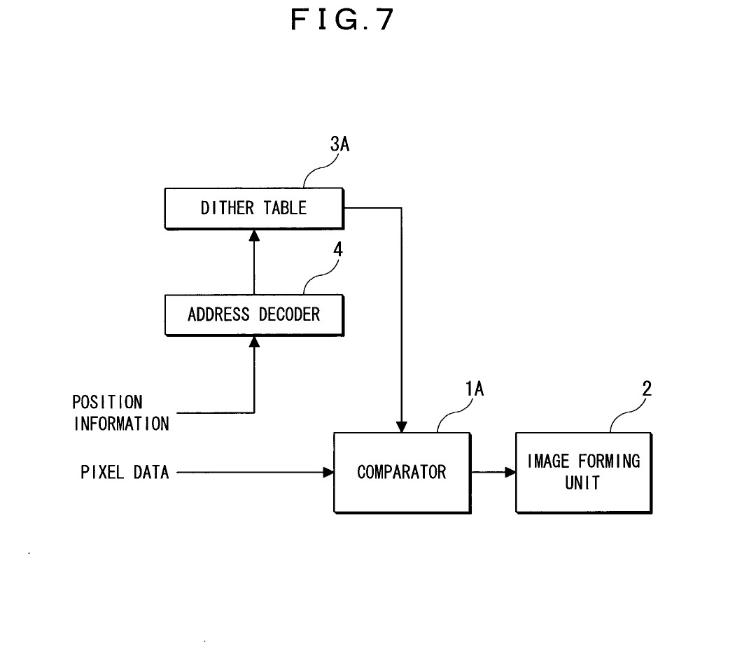

FIG. 7 is a block diagram showing an arrangement of an image forming apparatus as a first embodiment of the present invention. As shown in FIG. 7, the image forming apparatus of the first embodiment (e.g., an ink jet printer) is arranged to include a comparator 1A, an image forming unit 2, a dither table 3A and an address decoder 4.

Also in the first embodiment, each pixel data of the inputted image data supplied to the ink jet printer has 256 levels of tone (i.e., tone number 0 to tone number 255), for example. When the ink jet printer receives the data, the printer converts a value given to each pixel into any of aforesaid levels 0 to 5. Then, the ink jet printer forms a dot with a size corresponding to the converted result in each pixel region. Thus, a multilevel gray scale image can be created.

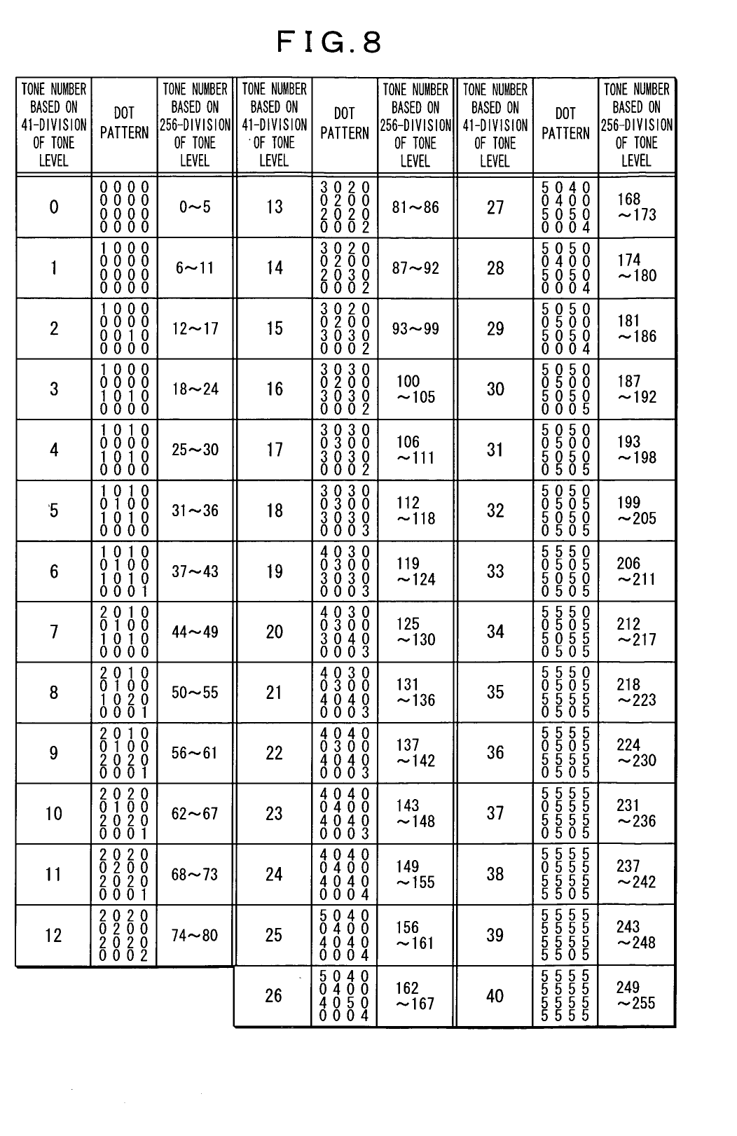

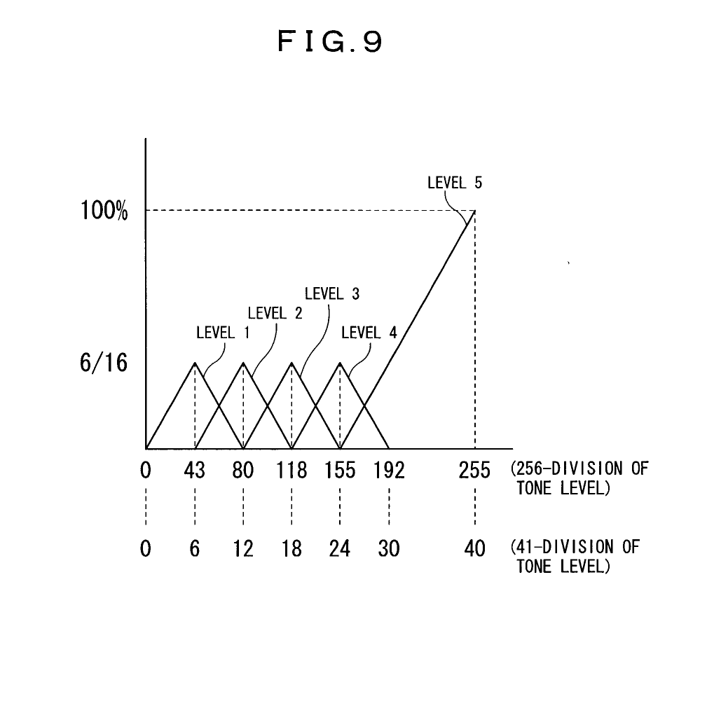

At this time, in the first embodiment, an ordered dither method is employed as a method for converting a value of each pixel in the inputted image data into the aforesaid six levels, i.e., levels of 0 to 5. Now, concrete description will be made with reference to FIGS. 8 and 9.

In the image forming apparatus of the first embodiment (ink jet printer), for example, a threshold value mask of 4×4 matrix (4×4 dither matrix) is utilized to convert the aforesaid inputted image data (respective pixel values, or tone number) into any of 41 kinds of 4×4 dot patterns shown in FIG. 8, for example, for every 4×4 pixel block. That is, the first embodiment handles the inputted image data based on the 256-division of tone levels as 4×4 dot pattern based on 41-division of tone levels.

In FIG. 8, dot patterns after undergoing the aforesaid conversion are expressed by numerals of 0 to 5 representing the above-described levels. In this figure, there are shown 1^{st} to 41^{st} dot patterns (all dot patterns of tone number 0 to tone number 40).

Now, description will be made with reference to FIG. 8 on how the numeral representing the dot size level is incremented at the leftmost pixel region of the uppermost row (first row of first column) of the 4×4 pixel block. For example, if the inputted image data value (tone number) ranges from 0 to 5, the dot size level takes a value of level 0. If the inputted image data value (tone number) ranges from 6 to 43, the dot size level takes a value of level 1. If the inputted image data value (tone number) ranges from 44 to 80, the dot size level takes a value of level 2. If the inputted image data value (tone number) ranges from 81 to 118, the dot size level takes a value of level 3. If the inputted image data value (tone number) ranges from 119 to 155, the dot size level takes a value of level 4. And if the inputted image data value (tone number) ranges from 156 to 255, the dot size level takes a value of level 5. In this way, the aforesaid threshold value mask is determined in advance.

In the first embodiment, other threshold value elements are determined in a similar manner. That is, a numeral of threshold value mask entering a cell at i-th row of j-th column (i=1, 2, 3, 4, & j=1, 2, 3, 4) is determined in advance so that the value of the inputted pixel data are converted as follows.

Numeral entering a cell at first row of second column: If the value of inputted image data ranges from 0 to 205, the dot size level takes a value of level 0. If the value of inputted image data ranges from 206 to 255, the dot size level takes a value of level 5.

Numeral entering a cell at first row of third column: If the value of inputted image data ranges from 0 to 24, the dot size level takes a value of level 0. If the value of inputted image data ranges from 25 to 61, the dot size level takes a value of level 1. If the value of inputted image data ranges from 62 to 99, the dot size level takes a value of level 2. If the value of inputted image data ranges from 100 to 136, the dot size level takes a value of level 3. If the value of inputted image data ranges from 137 to 173, the dot size level takes a value of level 4. And if the value of inputted image data ranges from 174 to 255, the dot size level takes a value of level 5.

Numeral entering a cell at first row of fourth column: If the value of inputted image data ranges from 0 to 223, the dot size level takes a value of level 0. If the value of inputted image data ranges from 224 to 255, the dot size level takes a value of level 5.

Numeral entering a cell at second row of first column: If the value of inputted image data ranges from 0 to 242, the dot size level takes a value of level 0. If the value of inputted image data ranges from 243 to 255, the dot size level takes a value of level 5.

Numeral entering a cell at second row of second column: If the value of inputted image data ranges from 0 to 30, the dot size level takes a value of level 0. If the value of inputted image data ranges from 31 to 67, the dot size level takes a value of level 1. If the value of inputted image data ranges from 68 to 105, the dot size level takes a value of level 2. If the value of inputted image data ranges from 106 to 142, the dot size level takes a value of level 3. If the value of inputted image data ranges from 143 to 180, the dot size level takes a value of level 4. And if the value of inputted image data ranges from 181 to 255, the dot size level takes a value of level 5.

Numeral entering a cell at second row of third column: If the value of inputted image data ranges from 0 to 230, the dot size level takes a value of level 0. If the value of inputted image data ranges from 231 to 255, the dot size level takes a value of level 5.

Numeral entering a cell at second row of fourth column: If the value of inputted image data ranges from 0 to 198, the dot size level takes a value of level 0. If the value of inputted image data ranges from 199 to 255, the dot size level takes a value of level 5.

Numeral entering a cell at third row of first column: If the value of inputted image data ranges from 0 to 17, the dot size level takes a value of level 0. If the value of inputted image data ranges from 18 to 55, the dot size level takes a value of level 1. If the value of inputted image data ranges from 56 to 92, the dot size level takes a value of level 2. If the value of inputted image data ranges from 93 to 130, the dot size level takes a value of level 3. If the value of inputted image data ranges from 131 to 167, the dot size level takes a value of level 4. And if the value of inputted image data ranges from 168 to 255, the dot size level takes a value of level 5.

Numeral entering a cell at third row of second column: If the value of inputted image data ranges from 0 to 217, the dot size level takes a value of level 0. If the value of inputted image data ranges from 218 to 255, the dot size level takes a value of level 5.

Numeral entering a cell at third row of third column: If the value of inputted image data ranges from 0 to 11, the dot size level takes a value of level 0. If the value of inputted image data ranges from 12 to 49, the dot size level takes a value of level 1. If the value of inputted image data ranges from 50 to 86, the dot size level takes a value of level 2. If the value of inputted image data ranges from 87 to 124, the dot size level takes a value of level 3. If the value of inputted image data ranges from 125 to 161, the dot size level takes a value of level 4. And if the value of inputted image data ranges from 162 to 255, the dot size level takes a value of level 5.

Numeral entering a cell at third row of fourth column: If the value of inputted image data ranges from 0 to 211, the dot size level takes a value of level 0. If the value of inputted image data ranges from 212 to 255, the dot size level takes a value of level 5.

Numeral entering a cell at fourth row of first column: If the value of inputted image data ranges from 0 to 236, the dot size level takes a value of level 0. If the value of inputted image data ranges from 237 to 255, the dot size level takes a value of level 5.

Numeral entering a cell at fourth row of second column: If the value of inputted image data ranges from 0 to 192, the dot size level takes a value of level 0. If the value of inputted image data ranges from 193 to 255, the dot size level takes a value of level 5.

Numeral entering a cell at fourth row of third column: If the value of inputted image data ranges from 0 to 248, the dot size level takes a value of level 0. If the value of inputted image data ranges from 249 to 255, the dot size level takes a value of level 5.

Numeral entering a cell at fourth row of fourth column: If the value of inputted image data ranges from 0 to 36, the dot size level takes a value of level 0. If the value of inputted image data ranges from 37 to 73, the dot size level takes a value of level 1. If the value of inputted image data ranges from 74 to 111, the dot size level takes a value of level 2. If the value of inputted image data ranges from 112 to 148, the dot size level takes a value of level 3. If the value of inputted image data ranges from 149 to 186, the dot size level takes a value of level 4. And if the value of inputted image data ranges from 187 to 255, the dot size level takes a value of level 5.

As described above, a set of threshold values for converting the pixel data into the dot size level are predetermined in advance for each cell of the 4×4 pixel block. Thus, a set of the threshold value masks is prepared in advance. The present invention is not limited to the above-described concrete set of threshold values.

FIG. 9 is a graph illustrating a relationship between a rate of number of pixel regions filled with dots of the respective levels (1 to 5) to the total pixel regions constituting the 4×4 dot pattern shown in FIG. 8, and 256-division tone levels and 41-division tone level of 4×4 dot pattern. As shown in FIG. 9, the 41-division tone levels (tone numbers 0 to 40) of the dot patterns shown in FIG. 8 are associated with the 256-division tone levels of the inputted image data.

By using the above-described threshold value mask, the dot pattern of the present embodiment formed of dots filling the cells constituting the 4×4 matrix is determined in accordance with the increase of tone number as follows. Initially, the cells constituting the 4×4 matrix are filled with a dot of level 1 one by one as the tone number is incremented. If all of six cells at predetermined positions are filled with six dots of level 1, then the dot of level 1 is replaced with a dot of level 2 one by one. If all of the six level-1 dots are replaced with the level-2 dots, then the dot of level 2 is replaced with a dot of level 3 one by one. In this way, the dot replacement is carried out in the similar manner in accordance with the increase of the tone number. That is, if all of the six level-2 dots are replaced with the level-3 dots, then the dot of level 3 is replaced with a dot of level 4 one by one. If all of the six level-3 dots are replaced with the level-4 dots, then the dot of level 4 is replaced with a dot of level 5 one by one. If all of the six level-4 dots are replaced with the level-5 dots, then the remaining ten cells having not been filled with a dot yet are filled with a level-5 dot one by one. When all of the cells (100%) constituting the 4×4 matrix are filled with the dot of level 5 (i. e., the matrix is applied with solid painting of dot), then this state corresponds to the state of tone number of 255.

In other words, the set of dot patterns of the present embodiment is determined as follows. That is, a dot of first size falling within a predetermined range (level 1 to level 4) is assigned to the pixel regions constituting the 4×4 matrix one by one in accordance with the tone number of the inputted image data. If the rate of the number of pixel regions filled with the first size dot to the total number of the pixel regions constituting the matrix reaches a predetermined rate (in this case, 6/16), then the dots of the first size are replaced with a dot of second size (levels of 2 to 5) which is larger than the first size one by one in accordance with the increase of the tone number. Furthermore, if all of the level-4 dots (first size) are replaced with the level-5 dots, the level-5 dot is assigned one by one to a pixel region constituting the 4×4 pixel block which has not been filled with any dot yet, in accordance with the increase of the tone number, until all of the pixel regions constituting the 4×4 pixel block are filled with the dots of level 5. In this way, a set of dot patterns employed in the present embodiment is created.

Meanwhile, in the image forming apparatus (ink jet printer) of the first embodiment shown in FIG. 7, the comparator 1A functions similarly to the dot size determining unit 1 shown in FIG. 1. That is, the comparator determines a size of dot to be formed on each pixel region (data for dithering) based on the inputted image data (pixel data/tone number), and supplies the data to the image forming unit 2.

In other words, the comparator 1A determines a size of dot to be formed on each pixel region as a matrix-like dot pattern (4×4 dot pattern) for each matrix-like pixel block corresponding to the dither matrix which is selected from the set of dither matrices (threshold value mask) based on the tone number. In more concretely, the comparator compares the pixel data (tone number) as an inputted image data with a threshold value corresponding to the position information of the pixel data which is read from the dither table 3A, and determines the dot size.

The image forming unit 2 functions similarly to that shown in FIG. 1. In the first embodiment, the image forming unit forms the dot having a size determined by the comparator 1A in the pixel region corresponding to the dot. Thus, a multilevel gray scale image is created.

The dither table 3A is a unit for holding the threshold value mask which has been described with reference to FIGS. 8 and 9. The address decoder 4 is a unit for identifying the correspondence of each position information to any of the cell in the threshold mask based on the position information supplied to the image forming apparatus of the first embodiment together with the inputted image data. In other words, the address decoder decides the correspondence of the aforesaid numbers of i and j to the cell value by decoding the address information.

A threshold value of a cell corresponding to the position information (i, j) resulting from the decoding of the address decoder 4 is read from the dither table 3A, and the comparator 1A compares the threshold value with the actual inputted image data (pixel data/tone number).

At this time, the threshold value mask described with reference to FIGS. 8 and 9 are stored in advance in the dither table 3A. The held threshold value is read from the dither table 3A in accordance with the decoding result of the address decoder 4 and the read threshold value is supplied to the comparator 1A. With this operation, the dither table 3A can effect a function similar to that of the preventing means 3 shown in FIG. 1. In the first embodiment, the dither table can effect the following preventing function.

First preventing function: Function for preventing the comparing unit 1A from selecting a dot pattern in which dots having a size falling within a predetermined range (levels of 1 to 4) are continuously arrayed in pixel regions which constitute the 4×4 pixel block and are neighboring one another.

Second preventing function: Function for preventing the comparing unit 1A from selecting a dot pattern in which dots having the size falling within the predetermined range are assigned to a number of pixel regions exceeding a predetermined rate with respect to the all number of pixel regions constituting one 4×4 pixel block (in the first embodiment, the rate is set to 6/16).

The dither table 3A has a set of threshold values registered for determining a dot size (level) so as to be correspondent to the (i, j) element of the threshold value mask. The dither table will be described together with a concrete example described with reference to FIG. 8.

For example, if the position information of the inputted image data is of (i, j)=(1, 1), i.e., the position information is of a cell at first row of first column, values of 5, 43, 80, 118, 155 are registered as threshold values. If the position information of the inputted image data is of (i, j)=(2, 3), i.e., the position information is of a cell at second row of third column, a value of 230 are registered as a threshold value.

With the above threshold value registration, if the comparator 1A is supplied with information of a tone number of a position corresponding to the cell at first row of first column, the tone number is compared with the threshold values of 5, 43, 80, 118, 155. If the tone number is equal to or smaller than 5, level 0 is set to the dot size. If the tone number is equal to or smaller than 43, level 1 is set to the dot size. If the tone number is equal to or smaller than 80, level 2 is set to the dot size. If the tone number is equal to or smaller than 118, level 3 is set to the dot size. If the tone number is equal to or smaller than 155, level 4 is set to the dot size. And if the tone number exceeds 155, level 5 is set to the dot size. In this way, the dot size is determined. Further, if the comparator 1A is supplied with information of a tone number of a position corresponding to the cell at second row of third column, the tone number is compared with the threshold value of 230. If the tone number is equal to or smaller than 230, level 0 is set to the dot size, and if the tone number exceeds 230, level 5 is set to the dot size. In this way, the dot size is determined. Accordingly, in the first embodiment, similarly to the ordinary ordered dither method, the tone level to be generated can be uniquely determined based on the position of the pixel and the image data (tone number) of the pixel.

When the above-described image forming apparatus of the first embodiment is utilized, also in the first embodiment, dot groups similar to those examples shown in FIGS. 2 to 5 can be formed to create a multilevel gray scale image. That is, 41 kinds of dot patterns shown in FIG. 8 are utilized so that the 256-divided tone levels of the inputted image data is associated with any of the dot patterns, and an image can be created by using dot patterns in a domain which can make the positional deviation inconspicuous.

At this time, as has been described with reference to FIGS. 8 and 9, if dots of the first level are assigned to the predetermined number of pixel regions of which rate to the 4×4 pixel block exceeds the predetermined rate (6/16) in accordance with the tone number, then the dots of the first level are replaced with dots of the second level. As a consequence, dot patterns prepared in the first embodiment will not contain a certain kind of dot pattern in which any of levels-1, -2, -3, and -4 dots is formed and arrayed on pixel regions in left-and-right direction or up-and-down direction continuously.

As described above, according to the first embodiment, the image forming apparatus selects only dot patterns involved in a domain in which it is possible to suppress the manifestation of the positional deviation for creating an image. Moreover, any of levels-1, -2, -3, and -4 dots can be prevented from being arrayed on pixel regions in left-and-right direction or up-and-down direction continuously.

Accordingly, even if slight deviation or the like is caused in the ink drop traveling direction and any irregular dot formation is brought about between the dot rows adjacent to each other, the portion of the image having the irregular dot formation brought about will not result in a conspicuous gap (see FIG. 17), and the irregular dot formation will not cause serious influence on the image quality.

That is, even if deviation in the dot array forming position is brought about from an ideal position due to a problem of addressability, causing a fluctuation in an interval of the dot array in the longitudinal direction or the lateral direction, the change in the dot forming condition due to the positional deviation is made inconspicuous, with the result that the image quality can be reliably prevented from being deteriorated. As a consequence, it becomes unnecessary to secure a stringent precision for the positional deviation caused from the problem of addressability. Thus, a high quality image can be created.

While in the above-described first embodiment description has been made on a case in which each of the pixel block, the threshold value mask and the dot pattern is a 4×4 matrix, and six levels of dot sizes (tone levels) are prepared, the present invention is not limited to the matrix arrangement and the dot size preparation. In fact, each of an actual pixel block, a threshold value mask and a dot pattern is 256×256 matrix and at least 16×16 matrix is desirable for the pixel block, the threshold value mask and the dot pattern.

While in the above-described first embodiment description has been made on a case in which the predetermined rate serving as a reference of dot number filling cells of a dot pattern is set to 6/16, the present invention is not limited to this case. For example, the image forming apparatus as an embodiment of the present invention may be additionally provided with a function for changing the setting of the rate depending on the dot size (tone level) or a function for changing the same depending on the surrounding image condition (pixel layout, density or the like) of the target pixel block. If the image forming apparatus as an embodiment of the present invention is additionally provided with the former function, great advantage can be expected when the dot size is larger than the dot pitch (pixel pitch).

Furthermore, while in the above-described first embodiment the present invention is applied to a case in which a multilevel gray scale image is created by using an ordered dither method, the present invention is not limited to this case. That is, it is needless to say that the present invention can be similarly applied to a case in which a multilevel gray scale image is created by using various kinds of methods such as a density pattern method, an error diffusion method, blue noise mask method, a digital screening method. And also it is needless to say that advantages similar to those of the first embodiment can be obtained.

Now description will be hereinafter made on a second embodiment in which the present invention is applied to an image forming apparatus for creating a multilevel gray scale image by using an error diffusion method.

[2] Description of Second Embodiment

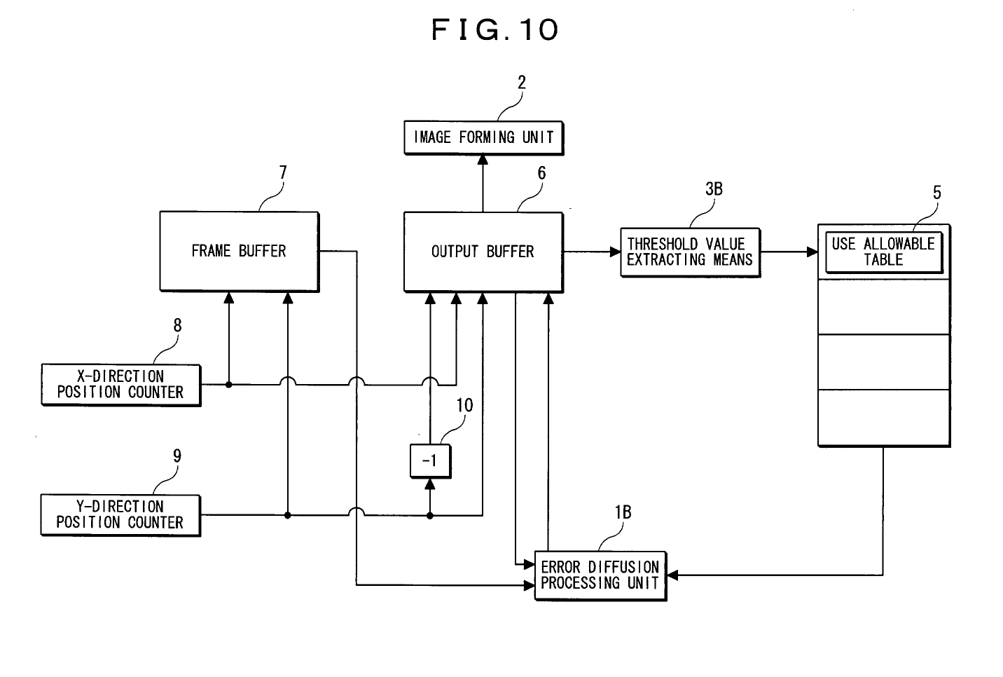

FIG. 10 is a block diagram showing an arrangement of an image forming apparatus as a second embodiment of the present invention. As shown in FIG. 10, the image forming apparatus (e.g., ink jet printer) of the second embodiment is arranged to include an error diffusion processing unit 1B, an image forming unit 2, threshold value extracting means 3B, a use allowable table 5, an output buffer 6, a frame buffer 7, an X-direction position counter 8, a Y-direction position counter 9 and a subtracter 10.

The frame buffer 7 is a unit for storing therein the inputted image data (original image). The X-direction position counter 8 and the Y-direction position counter 9 are units for outputting pieces of pixel data one by one to the error diffusion processing unit 1B while scanning the image data within the frame buffer 7.

In the present embodiment, the X-direction (lateral direction) is set in the main scanning direction and the Y-direction (longitudinal direction) is set in the sub-scanning direction. When the X-direction position counter 8 starts counting from zero and the count reaches eight (number of pixels arrayed in the lateral direction), then the count of the Y-direction position counter 9 is incremented by one row amount and the count of the X-direction position counter 8 is reset to zero. When the count of the Y-direction position counter 9 reaches a predetermined number (number of pixels arrayed in the longitudinal direction), then the count of the Y-direction position counter 9 is reset to zero.

The error diffusion processing unit 1B is a unit functioning in a manner similar to that of the dot size determining unit 1 shown in FIG. 1. The error diffusion processing unit employs an error diffusion method. The error diffusion processing unit carries out an error diffusion processing based on the image data stored in the frame buffer 7. Also, the error diffusion processing unit compares a tone number (image data) of a target pixel region having undergone the error diffusion processing with a plurality of threshold values stored in the use allowable table 5 which will be described later on, so as to determine a tone level corresponding to the tone number. Thereafter, the error diffusion processing unit determines the size of dot to be formed on the target pixel region depending on the tone level.

In the present embodiment, for example, the tone levels correspond to the aforesaid levels 0 to 5, respectively, and the tone levels correspond directly to the dot sizes, respectively.

The error diffusion processing unit 1B effects the aforesaid comparing processing on the target pixel region so as to select a threshold value that is the most approximate to the tone number of the target pixel region, and determines the tone number. Thereafter, the error diffusion processing unit carries out calculation to determine the error of the tone number with respect to the selected threshold value, and diffuses the error over the subsequent pixel region in accordance with a predetermined scheme (e.g., Floyd and Steinberg method, Javis, Judice and Ninke method, Stucki method, and so on).

Also the image forming apparatus of the second embodiment is provided with the preventing means 3 shown in FIG. 1. Owing to the function thereof, it becomes possible to avoid a dot size arrangement in which the size of dot formed in the target pixel region is identical to the size of dot having been formed in the pixel region adjacent to the target pixel region in the Y-direction (sub-scanning direction).

In order to implement the above-described function, the image forming apparatus of the second embodiment employs the threshold value extracting means 3B, the use allowable table 5, the output buffer 6 and the subtracter 10.

The use allowable table (threshold table) 5 is a unit for storing therein a plurality of threshold values allowable to be utilized when the error diffusion processing unit 1B carries out the aforesaid comparing processing for determining the tone level. The threshold values respectively correspond to a plurality of threshold values for a certain cell to be held in the dither table 3A which has been described together with the first embodiment, for example.

The output buffer 6 is a unit for storing therein data resulting from the processing effected by the error diffusion processing unit 1B on each pixel region so that the resulting data is associated with the position of the pixel region.

The subtracter 10 is a unit for subtracting one from the value outputted from the Y-direction position counter 9 so as to create information indicative of a position of the adjacent pixel region which is adjacent to the target pixel region in the Y-direction (sub-scanning direction) (position adjacent to a pixel region in the Y-direction which has undergone the processing during the preceding processing). The subtracter supplies the resulting information to the output buffer 6. The output buffer 6 receives an output from the X-direction position counter 8 and an output from the subtracter 10. The output buffer 6 outputs a value registered on a pixel region having undergone the processing which is located in a row of pixel regions preceding the row of the current target pixel region (value as a result of processing, i.e., image data after undergoing the converting processing).

The threshold value extracting means (preventing means) 3B extracts from the use allowable table 5 a threshold value corresponding to the value supplied from the output buffer 6 before the error diffusion processing unit 1B determines the tone level of the target pixel region.

The image forming unit 2 serves as the same function as that shown in FIG. 1. The image forming unit 2 of the second embodiment is a unit for forming a dot having a size determined by the error diffusion processing unit 1B on a pixel region corresponding to the dot. Thus, a multilevel gray scale image can be created. At this time, in the present embodiment, all of the inputted image data stored in the frame buffer 7 are subjected to the error diffusion processing 1B. When all of the resultant data are stored in the output buffer 6, the image forming unit 2 carries out image forming processing based on the data stored in the output buffer 6.

According to the image forming apparatus of the second embodiment arranged as described above, the threshold value extracting means 3B extracts from the use allowable table 5 a threshold value (tone level) utilized when the tone level determination is made on the pixel region which is preceding by one row in the Y-direction relative to the target pixel region, and thereafter the error diffusion processing unit 1B determines the tone level of the target pixel region.

Accordingly, the target pixel region comes to have a tone level set to other than a tone level of the pixel region which is preceding by one in the Y-direction to the target pixel region. Therefore, it becomes possible to avoid a dot size arrangement in which the size of dot formed in the target pixel region is identical to the size of dot having been formed in the pixel region adjacent to the target pixel region in the Y-direction (sub-scanning direction).

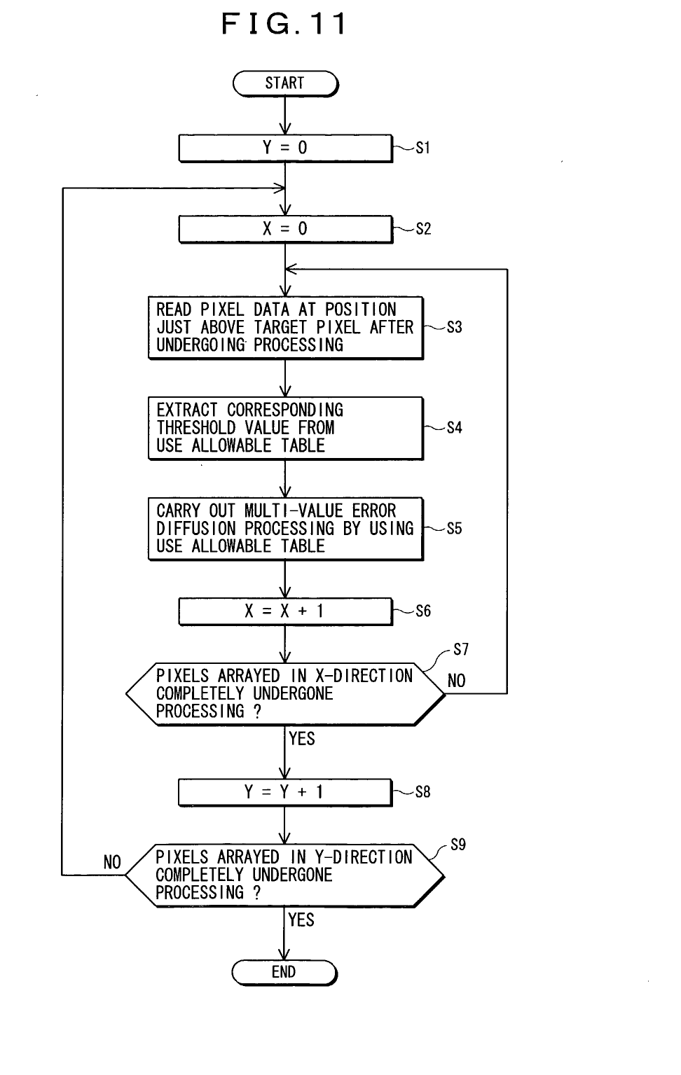

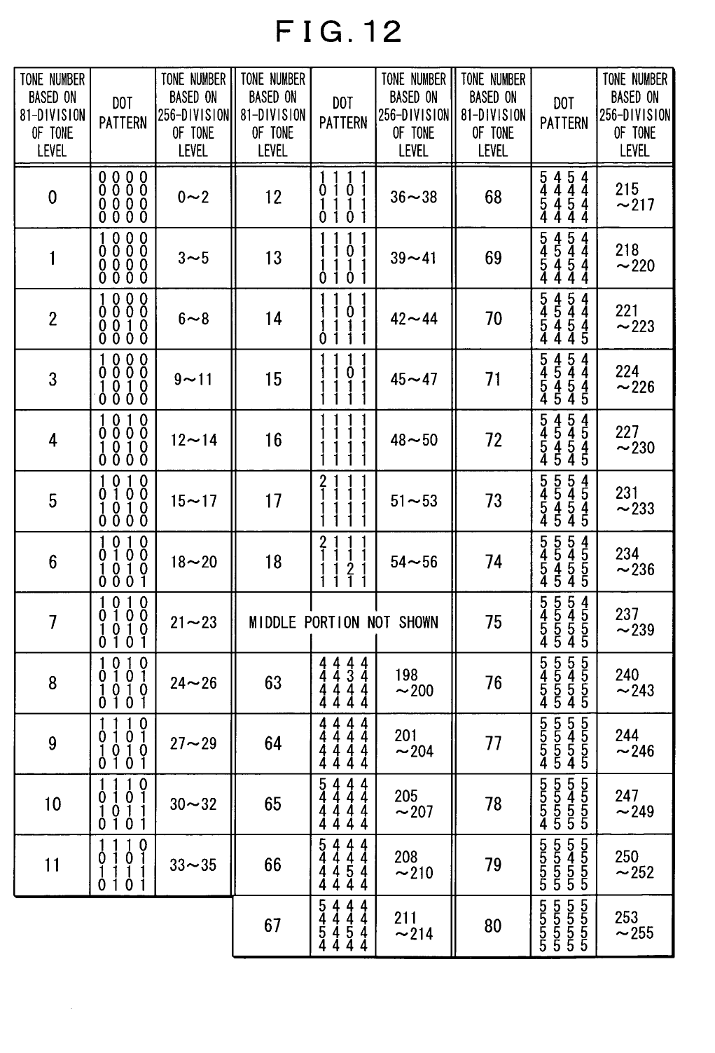

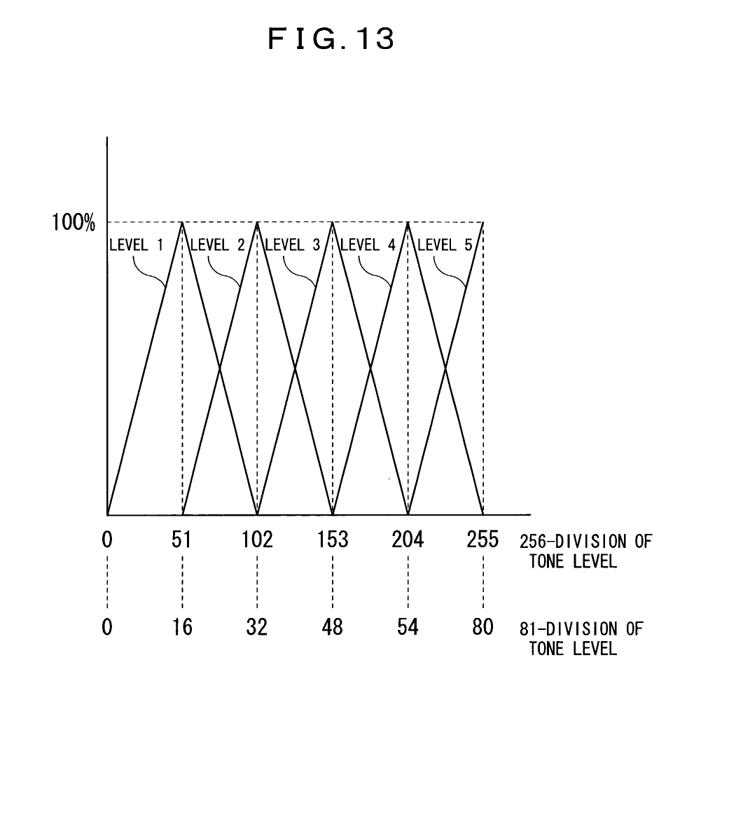

Now an operation of the image forming apparatus of the second embodiment will be hereinafter described in more detail with reference to a flowchart (steps S1 to S9) shown in FIG. 11.

Initially, when an original image (inputted image data) is stored in the frame buffer 7, a reset signal (not shown) is supplied to the X-direction position counter 8 and the Y-direction position counter 9 to reset the counters. Thus, the counts of the position counters 8 and 9 are set to “0” (step S1 and S2).

Thereafter, the position counters 8 and 9 carry out increment operation on their counts so that the image data stored in the frame buffer 7 are scanned. In this way, processing of steps S2 to S9 can be repeatedly effected on respective pixel data.

That is, data reading is effected on the output buffer 6 so that the output buffer generates a value (image data after conversion) of a pixel region having undergone the processing which is located in a row of pixel regions preceding by one in the Y-direction to the pixel region which is currently handled as a target pixel region by the error diffusion processing unit 1B (step S3). Then, the threshold extracting means 3B extracts from the use allowable table 5 a threshold value corresponding to the value supplied from the output buffer 6. Thus, the use allowable table 5 is created for the pixel region which is currently handled as a target pixel region (step S4).

Then the error diffusion processing unit 1B effects an ordinary error diffusion processing on the target pixel region and executes the dot size determining processing by using only the threshold values (tone levels) stored in the use allowable table 5 created at step S4 (step S5). The result of processing thereof is written in the output buffer 6.

Subsequently, the count of the X-direction position counter 8 is incremented by one (step S6) and it is determined whether the processing on the all pixel regions arrayed in the X-direction (processing of one row amount) is completed or not (step S7).

If it is determined that the processing is not completed yet (NO route at step S7), then the processing returns to step S3 and the similar processing is repeated. On the other hand, if it is determined that the processing is completed (YES route at step S7), then the count of the Y-direction position counter 9 is incremented by one (step S8) and it is determined whether the processing on the all pixel regions arrayed in the Y-direction (processing of all pixel regions) is completed or not (step S9).

If it is determined that the processing is not completed yet (NO route at step S9), then the processing returns to step S2 and the similar processing is repeated. On the other hand, if it is determined that the processing is completed (YES route at step S9), then the whole processing is concluded.

As described above, if the processing has been completed on all the pixel regions, the whole data stored in the output buffer 6 are sent to the image forming unit 2 (printing mechanism) and printed material is created based on the data.

As described above, according to the image forming apparatus of the second embodiment, it becomes possible to avoid a dot size arrangement in which the size of dot formed in the target pixel region is identical to the size of dot having been formed in the pixel region adjacent to the target pixel region in the Y-direction (sub-scanning direction). Accordingly, it becomes possible to prevent dots of the same size from being formed and arrayed continuously in the Y-direction (sub-scanning direction).

Accordingly, even if slight deviation or the like is caused in the ink drop traveling direction and any irregular dot formation is brought about between the dot rows adjacent to each other, the portion of the image having the irregular dot formation brought about will not result in a conspicuous gap (see FIG. 17), and the irregular dot formation will not cause serious influence on the image quality.

That is, even if deviation in the dot array forming position is brought about from an ideal position due to a problem of addressability, causing a fluctuation in an interval of the dot array in the longitudinal direction (Y-direction, sub-scanning direction), the irregularity in the dot forming condition due to the positional deviation is made inconspicuous, with the result that the image quality can be reliably prevented from being deteriorated. As a consequence, it becomes unnecessary to secure a stringent precision for the positional deviation caused from the problem of addressability. Thus, a high quality image can be created.

[3] Other Disclosure

The present invention is not limited to the above-described embodiment but various changes and modifications can be effected without departing from the gist of the present invention.

For example, while in the above-described embodiments description has been made on a case where the present invention is applied to an ink jet printer, the present invention is not limited thereto. That is, the present invention can be applied to a thermal printer or the like and the similar advantages to those described above can be expected.

### INDUSTRIAL APPLICABILITY

As described above, according to the present invention, it becomes possible to avoid a dot pattern in which dots of the same size are formed and arrayed continuously in pixel regions neighboring one another. Owing to the effect of the present invention, even if deviation in the dot array forming position is brought about from an ideal position due to a problem of addressability, causing a fluctuation in an interval of the dot array, the irregularity in the dot forming condition due to the positional deviation is made inconspicuous, with the result that the image quality can be reliably prevented from being deteriorated. As a consequence, it becomes unnecessary to secure a stringent precision for the positional deviation caused from the problem of addressability. Thus, a high quality image can be created.

Accordingly, the present invention can be applied to an image forming apparatus such as an ink jet printer and a thermal printer which employ various kinds of methods such as density pattern method, an ordered dither method, an error diffusion method, a blue-noise mask method, a digital screening method and so on to form a multilevel gray scale image. Therefore, it is considered that the applicability of the present invention is extremely high.

1. An image forming apparatus characterized by comprising:
a dot size determining unit (1, 1A, 1B) for determining a size of dot to be formed on each pixel region based on inputted image data;
an image forming unit (2) for forming a dot, having a size determined by the dot size determining unit (1, 1A, 1B), in the pixel region corresponding to the dot so as to create a multilevel gray scale image; and
preventing means (3, 3A, 3B) for preventing a dot size from being determined by the dot size determining unit (1, 1A, 1B) in such a manner that dots having an identical size falling within a predetermined range are continuously arrayed in pixel regions neighboring one another.

2. An image forming apparatus according to claim 1, characterized in that the dot size determining unit (1A) refers to a predetermined set of dither matrices each time the dot size determining unit is supplied with a piece of image data corresponding to a matrix-like pixel block, and selects a matrix-like dot pattern corresponding to the pixel block by determining the size of each dot to be formed in a corresponding pixel region constituting the pixel block so that a tone number of the image data corresponding to the matrix-like pixel block is associated with corresponding one of the dither matrices, and that
the preventing means (3A) is arranged to prevent the dot size determining unit (1A) from selecting a dot pattern in which the dots having an identical size falling within a predetermined range are continuously arrayed in the pixel regions which constitute the pixel block and are neighboring one another.

3. An image forming apparatus according to claim 2, characterized in that the preventing means (3A) is arranged to prevent the dot size determining unit (1A) from selecting a dot pattern in which the number of pixel regions filled with a dot having a size falling within a predetermined range exceeds a predetermined rate to the total number of pixel regions constituting the pixel block.

4. An image forming apparatus according to claim 3, characterized in that the dot size determining unit (1A) selects a dot pattern from among a set of possible dot patterns which are prepared in such a manner that a dot of first size falling within the predetermined range is increased one by one in accordance with the tone number and arrayed in any of the pixel regions constituting the pixel block, and when the number of pixel regions filled with the dot of first size exceeds the predetermined rate to the total number of pixel regions, the dot of first size is replaced one by one with a dot of second size which is larger than the dot of first size in accordance with the tone number.

5. An image forming apparatus according to claim 4, characterized in that the dot size determining unit (1A) selects a dot pattern from among a set of possible dot patterns which are prepared in such a manner that if the second size is one larger than the predetermined range, all dots of first size are replaced with the dots of second size and thereafter the dot of second size is assigned one by one to an empty pixel region of the pixel block in accordance with the tone number until all of the pixel regions constituting the pixel block are filled with the dot of second size.

6. An image forming apparatus according to any of claims 3 to 5, characterized in that the preventing means (3A) has a function for changing the setting of the rate depending on the size.

7. An image forming apparatus according to any of claims 3 to 5, characterized in that the preventing means (3A) has a function for changing the setting of the rate depending on the surrounding image condition of the pixel block.

8. An image forming apparatus according to claim 1, characterized in that the dot size determining unit (1B) employs an error diffusion method, and determines a size of dot to be formed on the target pixel region in such a manner that a tone level corresponding to the tone number is determined by comparing a tone number, having undergone the error diffusion processing based on the image data, with a plurality of threshold values and thereafter the size of dot to be formed on the target pixel region is determined depending on the tone level, and that
the preventing means (3B) is arranged to avoid a dot size arrangement in which the size of dot formed in the target pixel region is identical to the size of dot having been formed in the pixel region adjacent to the target pixel region in the sub-scanning direction.

9. An image forming apparatus according to claim 8, characterized in that the dot size determining unit (1B) includes a threshold table (5) for holding therein said plurality of threshold values utilized when the dot size determining unit (1B) carries out the comparing processing to determine the tone level, and that
the preventing means (3B) extracts from the threshold table (5) a threshold value which has been utilized as a reference for determining the tone level of the pixel region adjacent to the target pixel region before the dot size determining unit (1B) determines the tone level of the target pixel region.

10. A method of forming an image comprising the steps of:
determining a size of dot to be formed in each pixel region based on inputted image data; and
forming a multilevel gray scale image in such a manner that a dot having a size determined by the step of determining the dot size is formed in the pixel region corresponding to the dot, wherein
in the step of determining the dot size, control is effected to avoid a case in which dots having an identical size falling within a predetermined range are continuously arrayed in pixel regions neighboring one another.
